(19) United States
(12) Patent Application Publication
(10) Pub. No.: US 2006/0124612 A1
(43) Pub. Date: Jun. 15, 2006

(54) Generation of diffuse non-thermal atmosheric plasmas

(76) Inventors: Michael Kong, Loughborough (GB); Xutao Deng, Loughborough (GB)

Correspondence Address: WARE FRESSOLA VAN DER SLUYS &;ADOLPHSON, LLP, BRADFORD GREEN BUILDING 5, 755 MAIN STREET, P O BOX 224, MONROE, CT, 06468, US

(21) Appl. No.: 10/523,963

(22) PCT Filed: Aug. 7, 2003
(86) PCT No.: PCT/GB03/03485

§ 371 Date: Oct. 19, 2005

(30) Foreign Application Priority Data
Aug. 7, 2002 (GB) 0218299.6

(51) Int. Cl. B23K 9/00

(52) U.S. Cl. 219/121.36

(57) ABSTRACT

A method of generating non-thermal atmospheric gas plasmas using an applied voltage with specially-shaped waveforms. The waveforms are shaped to avoid energy wastage by attenuating the voltage in the period after current discharge has occurred. A control system may also be used to shape the applied voltage waveform in response to the gas discharge current.

### FIELD OF THE INVENTION

This invention relates to the generation of gas plasmas, and more particularly to the electrically-efficient production of diffuse non-thermal atmospheric gas plasmas.

### REVIEW OF THE ART KNOWN TO THE APPLICANT(S)

Nonthermal gas discharges generated at atmospheric pressure find widespread use for ozone production (see B. Eliasson and U. Kogelschatz, “Nonequilibrium volume plasma chemical-processing”, IEEE Trans. Plasma Science, vol. 19, pp. 1063-1077, 1991), pollution control (see B. M. Penetrante, J. N. Barsley, and M. C. Hsaio, “Kinetic analysis of non-thermal plasmas used for pollution control”, Japan. J. Appl. Phys. Vol. 36, pp. 5007-5017, 1997.), and surface modification of Polymer films (see J. Friedrich, L. Wigant, W. Unger, A. Lippitz, and H. Wittrich, “Corona, spark and combined UV and ozone modification of polymer films WeBP23”, Surface & Coatings Technology, vol. 98, pp. 879-885, 1998.). Typically, such atmospheric plasmas consist of many nanosecond-scale microdischarges of streamer-like filaments (see A. C. Gentile and M. J. Kushner, “Reaction chemistry and optimization of plasma remediation of NₓO_{y} from gas streams”, J. Appl. Phys. vol. 78, pp. 2074-2085, 1995.) and much is known of their fundamental properties and their applications (see also M. Baeva, A. Dogan, J. Ehlbeck, A. Pott, and J. Uhlenbusch, “CARS diagnostic and modeling of a dielectric barrier discharge”, Plasma Chem. Plasma Processing, vol. 19, pp. 445-466, 1999 and R. Hackam and H. Akiyama, “Air pollution control by electrical discharges”, IEEE Trans. Dielectrics and Electrical Insulation, vol. 7, pp. 654-683, 2000.). More recently it has been suggested that nonthermal atmospheric gas discharges can also be diffuse and luminous with the duration of their discharge current pulses in excess of sub-milliseconds (see E. E. Kunhardt, “Generation of large-volume, atmospheric-pressure, nonequilibrium plasmas”, IEEE Trans. Plasma Sci., vol. 28, pp. 189-200, 2000; M. J. Shenton and G. C. Stevens, “Surface modification of polymer surfaces: atmospheric plasma versus vacuum plasma treatments”, J. Physics. D: Appl. Phys., vol. 34, pp. 2761-2768, 2001 and F. Massines, A. Rabehi, Ph Decomps, R. B. Gadri, P. Segur, and C. Mayoux, “Experimental and theoretical study of a glow discharge at atmospheric pressure controlled by dielectric barrier”, Journal of Applied Physics, vol. 83, pp. 2950-2957, 1998.). Compared to their counterparts in the streamer-dominated mode, these diffuse nonthermal atmospheric plasmas have greater spatial uniformity, better temporal stability, and much lower gas temperature, typically in the range 75° C.-150° C. (see A. Schutze A, J. Y. Jeong, S. E. Babayan, J. Park, and G. S. Selwyn, “The atmospheric-pressure plasma jet: A review and comparison to other plasma sources”, IEEE Trans Plasma Sci, vol. 26, pp. 1685-1694, 1998.). These properties make them particularly attractive for a number of key materials processing applications such as etching, deposition, and structural modification of polymeric surfaces. These diffuse nonthermal atmospheric plasmas have been generated with dielectrically insulated electrodes at audio frequencies (see Massines et al, supra), with un-insulated electrodes at radio frequencies (see Schutze et al, supra), and at microwave frequencies (see Shenton and Stevens, supra). Apart from their desirable spatial and temporal characteristics, diff-use nonthermal atmospheric plasmas have different electrical and chemical properties from that of their streamer-dominated counterparts. While many of their fundamental properties remain to be fully understood, the focus of research has been largely experimental improvement of existing applications and empirical exploration of new applications.

For controlled and optimised performance of material processing, it is always desirable to be able to adjust and tailor plasma properties. In the case of diffuse nonthermal atmospheric plasmas, this has been pursued mainly through plasma rig designs and gas composition, and to a lesser extent through an appropriate choice of excitation frequency (See J. Park, I. Henins, W. Hermann, and G. S. Selwyn, “Gas breakdown in an atmospheric pressure radio-frequency capacitive plasma source”, J. Appl. Phys., vol. 89 15-19, 2001).

U.S. Pat. No. 6,228,330 teaches the use of atmospheric-pressure plasmas for the decontamination and sterilization of sensitive equipment and material, and provides evidence of their efficacy in inactivation of a number of bacterial spores. The patent describes a system for plasma recirculation, but discloses no shaping of the waveform of the applied voltage.

The European patent application number EP 1 040 839 descibes a multi-stage process for sterilization using a gas plasma. The application discloses no shaping of the waveform of the applied voltage.

U.S. Pat. No. 6,118,218 describes an atmospheric pressure plasma treater incorporating a porous metallic electrode. The application discloses no shaping of the waveform of the applied voltage.

A number of features of non-thermal gas plasmas are particularly important in regard to their applicability. First, the temperature of the gas plasma may be deleterious to objects with which the plasma comes into contact, for example during sterilization or surface decontamination. Second, the power dissipation in the plasma has a direct bearing on the energy efficiency of plasma generation, which is important for the overall economic efficiency of devices using the plasma, and is particularly important in applications remote from a readily-available supply of electrical power.

Accordingly, it is an object of the present invention to provide a means to generate atmospheric-pressure plasmas at increased energy efficiency and at low temperature, whilst retaining the desirable feature of a high density of active species.

### SUMMARY OF THE INVENTION

In accordance with the inventive concept, these objects are addressed by the use of an applied voltage that exhibits a waveform (as defined herein) which is truncated (as herein defined) and/or which decays asymmetrically from its peak value. Advantageously, the applied voltage, V, as a function of time, t, said time t being measured from any arbitrary instant, takes the form of a waveform, V(t), of cycle time T, wherein in at least one of the half cycles, i.e. between (t=i T) and (t=i T+T/2) or between (t=i T+T/2) and (t(i+1)T, where i takes integer values, the waveform is characterised by the magnitude of the integral of the voltage with respect to time being greater in the first half of said half cycle than in the second half of said half cycle. Advantageously also, the applied voltage, V, as a function of time, t, said time t being measured from any arbitrary instant, takes the form of a waveform, V(t), of cycle time T, wherein in at least one of the half cycles, i.e. between (t=i T) and (t=T+T/2) or between (t=i T+T/2) and (t=i+1)T), where i takes integer values, the waveform is characterised by a period of substantially constant voltage.

Also advantageously, the applied voltage may be defined by equation E1, below.

Also advantageously, the applied voltage may be defined by equation E2, below.

Also advantageously, the applied voltage may be defined by equation E3, below.

Preferably, the applied voltage may be generated by the action of a control system, said control system using a measurement of the plasma discharge current as an input signal. Included within the scope of the invention is a method of generating a gas plasma substantially as described herein with reference to and as illustrated by the accompanying drawings.

### BRIEF DESCRIPTION OF THE DRAWINGS

FIG. 1 is a graph showing the reduced ionization coefficient of argon as computed with a Boltzmann solver (circles) and with the source term technique (+) together with reduced ionization coefficient of nitrogen using the source term technique (solid line).

FIG. 2 is a graph showing typical voltage-current characteristics of a helium-nitrogen discharge under sinusoidal excitation with the gas voltage in solid curve, the discharge current in thick dashed curve, and the applied voltage in dot curve.

FIG. 3 is a graph showing a generalised peak-levelled waveform.

FIG. 4 is a graph showing (a) A pulsed excitation voltage (solid curve) at 10 kHz repetition frequency, made from a sinusoidal voltage (dashed curve) having its peaks levelled; and (b) time dependence of the peak-levelled excitation voltage (dot curve), the gas voltage (solid curve), and the discharge current (thick dashed curve).

FIG. 5 is graph showing normalized plasma power density (circles) and normalized electron density (diamonds) as a function of reduced magnitude of the applied voltage with 0.5% nitrogen.

FIG. 6 is a graph showing the normalized plasma power density (circles) and normalized electron density (diamonds) as a function of reduced magnitude of the applied voltage with no nitrogen impurities.

FIG. 7 is a graph showing the normalized electron density (circles) and normalized metastable density (diamonds) as a function of reduced magnitude of the applied voltage with 0.5% nitrogen impurities.

FIG. 8 is a graph showing a generalised tail-trimmed waveform.

FIG. 9 is a graph showing (a) a peak-levelled excitation voltage at 10 kHz repetition frequency (dashed curve) and with its pulse tail trimmed (solid curve); and (b) time dependence of the peak-levelled and tail-trimmed excitation voltage (dot curve), the gas voltage (solid curve), and the discharge current (thick dashed curve).

FIG. 10 is a graph showing (a) a sinusoidal excitation voltage at 10 kHz repetition frequency (dashed curve) and with its tail shaped with a Gaussian decay (solid curve); and (b) time dependence of the excitation voltage (dot curve), the gas voltage (solid curve), and the discharge current (thick dashed curve).

### THE INVENTIVE CONCEPT

The inventive concept considers pulsing plasma excitation voltage as a way to control and improve properties of diffuse nonthermal atmospheric plasmas. For streamer-dominated atmospheric gas discharges, pulsed plasma generation has been known to facilitate better energy efficiency and greater control of the glow-to-arc transition although this has never been achieved for diffuse, nonthermal atmosphere plasmas. If similar improvements could be achieved for such plasmas, it would be useful for applications where plasma power consumption is an important issue, for example aircraft cloaking and industry-scale surface treatment.

To illustrate the benefits of plasma pulsing in different plasma generation configurations, we will consider nonthermal atmospheric gas discharges generated in a helium-nitrogen mixture and between two dielectrically insulated parallel-plate electrodes. Specifically the inventive concept attempts to answer (1) whether pulsed plasma generation can lead to saving in electrical power needed to sustain the generated plasma; and (2) if so how pulse shape and width may be adjusted to enhance energy efficiency. The approach uses on a one-dimensional computer code (See X. T. Deng and M. G. Kong, “Parametric conditions for generation of stable atmospheric pressure nonthermal plasmas”, in the 2001 Annual Report, Conference on Electrical Insulation and Dielectric Phenomena 677 (IEEE Catalogue Number: 01CH37225), pp. 677-680, 2001) developed using a hydrodynamic model similar to those employed in most numerical studies for diffuse nonthermal atmospheric plasmas (See Massines et al, supra and F. Tochikubo, T. Chiba, and T. Watanabe, “Structure of low-frequency helium glow discharge at atmospheric pressure between parallel plate dielectric electrodes”, Japanese Journal of Applied Physics, vol. 38, pp. 5244-5250, 1999). The key features of the underlying model of diffuse nonthermal atmospheric plasmas as well as its numerical implementation will be described below, for clarity. Voltage-current characteristics of nonthermal atmospheric plasma under sinusoidal excitation will be used as an example to demonstrate the utility of this approach.

A Physical Model of Nonthermal Atmospheric Plasmas

Diffuse nonthermal atmospheric plasmas may be induced and sustained between two parallel-plate electrodes, each one optionally coated with a dielectric layer and connected externally to a sinusoidal voltage source, typically at voltages in excess of 1 kV, and at audio frequencies. The background gas is, for example, atmospheric helium mixed with a small fraction of nitrogen (up to 1%) at room temperature of 293K, and the dynamics of the generated nonthermal atmospheric plasma is described by the Boltzmann equation, well known in the art. It has been established that the hydrodynamic assumptions can be applied to diffuse nonthermal atmospheric plasmas (See Massines et al and Tochikubo et al, supra). This reduces the Boltzmann equations to the continuity and momentum transfer equations for electrons and ions, thus facilitating a macroscopic description of plasma dynamics without its microscopic details. On the other hand, the dynamics of electrons and ions are determined by the electric field in the space between the two parallel electrodes, which has two components, one induced by the externally applied excitation voltage and the other by space charges. The electric field can be calculated by solving Poisson's equation. In the one-dimensional limit, the Boltzmann equations and Poisson's equations are closely coupled together as follows

$$\begin{matrix}\frac{\partial {n}_{\pm }}{\partial t} = {S}_{\pm } ( r , t ) - \frac{\partial [ {n}_{\pm } ( r , t ) {W}_{\pm } ( r , t ) ]}{\partial r} + \frac{{\partial }^{2} [ {n}_{\pm } ( r , t ) {D}_{\pm } ( r , t ) ]}{\partial {r}^{2}} & ( 1 a ) \\ \frac{\partial {n}_{i}}{\partial t} = {S}_{i} ( r , t ) - \frac{\partial [ {n}_{i} ( r , t ) {W}_{i} ( r , t ) ]}{\partial r} + \frac{{\partial }^{2} [ {n}_{i} ( r , t ) {D}_{i} ( r , t ) ]}{\partial {r}^{2}} & ( 1 b ) \\ \frac{\partial E ( r , t )}{\partial r} = \frac{\vert e \vert}{{ɛ}_{0}} [ {n}_{+} ( r , t ) - {n}_{-} ( r , t ) ] & ( 1 c )\end{matrix}$$

where n₊ and n₋ are the ion and electron densities respectively, and nᵢ is the density of the i^{th} neutral species considered. S_{±} and Sᵢ are the source terms for charged particles and neutral species respectively. D and W are diffusion coefficient and drift velocity with subscripts −, +, and i denoting respectively electrons, ions, and i^{th} neutral species considered in the physical model. E is the electric field, |e| is the charge of the electron, ε₀ is the dielectric permittivity, and r is the variable representing the spatial position normal to the electrode. With the hydrodynamic assumptions, reaction rate coefficients, ionization coefficients, drift velocity, and diffusion coefficients can be approximated as a function of the electric field in the ionised gas between the two electrodes. Thus this physical model is similar to those used in Massines et al (supra) and Tochikubo et al, (supra). The values of these coefficients are obtained from relevant experiments and several rate compilation studies which will be discussed in greater detail below. These allow eqs. (1a) and (1b) to be solved to yield densities of electrons, ionic species, and metastables, which then allows through eq. (1c) calculation of electric field. Boundary conditions between the ionized gas and the dielectrically coated electrodes need to be carefully treated. To this end, a circuit equation is included to relate the electric field in the gas to the source voltage (the output voltage of the power supply) via a source resistor, Rₛ, and two serial capacitors each representing one dielectric coating layer. The numerical algorithm used to solve the above equations is essentially based on the Patankar scheme, and the discretization employs the upwind scheme (see S. Patankar, “Numerical heat transfer and fluid flow”, Hemisphere publishing Co, 1980).

The model considers reactions involving eight different species, namely (1) two ground-state neutral species, He(1¹S) and N₂(4⁰S); (2) two helium metastables, He(2³S) and He(2¹S); (3) electrons; (4) ground-state atomic helium ions, He⁺; (5) ground-state molecular helium ions, He₂⁺ (2³SΣᵤ⁺); and (6) ground state molecular nitrogen ions, N₂⁺. In total, the model considers 17 reactions, as detailed in Table 1 below, together with their reaction rates and reference sources. Products of these 17 reactions include two additional species, namely excited molecular helium (He*) and atomic nitrogen (N). Any subsequent reaction of these two additional species with the original eight species is not considered in the model. It is worth noting that the model is capable of evaluating production of molecular nitrogen ions that are not considered in reported numerical studies of diffuse nonthermal atmospheric discharges (e.g. Massines et al, supra and Tochikubo et al, supra).

TABLE 1
Reactions considered for a He—N₂ discharge and their rate coefficients

| | | | |
|---|---|---|---|
| No | Reaction | Reaction rate | Reference |

Direct ionization

| | | | |
|---|---|---|---|
| 1 | He + e → He⁺ + e + e | α₁ | 1, 2, 3 |
| 2 | N₂ + e → N₂⁺ + e + e | α₂ | 1, 4 |

Excitation

| 3 | He + e → He (2³S) + e | β₁ | | 5 |
|---|---|---|---|---|
| 4 | He + e → He (2¹S) + e | β₂ | | 5 |
| 5 | He (2³S) + 2He (1¹S) → He₂* + | 1.9 × 10⁻³⁴ | cm⁶/s | 6 |
| | He (1¹S) | | | |

De-excitation

| | | | | |
|---|---|---|---|---|
| 6 | He (2³S) + e → He (1¹S) + e | 4.2 × 10⁻⁹ | cm³/s | 7 |

Penning ionisation

| | | | | |
|---|---|---|---|---|
| 7 | He (2³S) + N₂ → He (1¹S) + | 8 × 10⁻¹¹ | cm³/s | 5, 8 |
| | N₂⁺ + e | | | |

Stepwise ionisation

| | | | | |
|---|---|---|---|---|
| 8 | He (2³S) + He (2³S) → He | 2.9 × 10⁻⁹ | cm³/s | 9 |
| | (1¹S) + He⁺ + e | | | |

Charge transfer

| | | | | |
|---|---|---|---|---|
| 9 | He⁺ + 2He (1¹S) → He₂⁺ + | 6.3 × 10⁻³² | cm⁶/s | 13, 5 |
| | He (1¹S) | | | |

Recombination

| | | | | |
|---|---|---|---|---|
| 10 | He⁺ + e → He (1¹S) | 2 × 10⁻¹² | cm³/s | 10 |
| 11 | He₂⁺ + e → He₂* | 5 × 10⁻¹⁶ | cm³/s | 11 |
| 12 | He⁺ + e + He → He (1¹S) + | 1 × 10⁻²⁷ | cm⁶/s | 10 |
| | He (2³S) | | | |
| 13 | He₂⁺+ e → He (1¹S) + e | 7.1 × 10⁻²⁰ | cm⁶/s | 13, 5 |
| 14 | He₂⁺+ e → 2He (2³S) + He | 5 × 10⁻⁹ | cm³/s | 6 |
| 15 | He₂⁺+ e + He → He₂* + He | 5 × 10⁻²⁷ | cm⁶/s | 11 |
| 16 | N₂⁺ + e → N + N | 4.8 × 10⁻⁸ | cm³/s | 8 |
| 17 | N₂⁺ + 2e → N₂ + e | 1.4 × 10⁻²⁶ | cm⁶/s | 12 |

References cited in Table 1
(1) F. Massines et al (supra)
(2) A. L. Ward, “Calculations of cathode-fall characteristics”, Journal of Applied Physics, vol. 33, pp. 2789-2794, 1964.
(3) J. Dutton, “A survey of electron swarm data”, J. Phys Chem. Ref. Data, vol. 4, pp. 577-856, 1975.
(4) I. Peres, N. Ouadoudi, L. C. Pitchford, and J. P. Boeuf, “Analytical formulation of ionization source term for discharge models in argon, helium, nitrogen, and silane”, J. Appl. Phys., vol. 72, pp. 4533-4536, 1992.
(5) R. Ben Gadri, “Numerical simulation of an atmospheric pressure and dielectric barrier controlled glow discharge”, PhD thesis, University Paul Sabatier of Toulouse, France, 1997.
(6) J. M. Pouvesle, A. Bouchoule, and J. Stevefelt, “Modeling of the charge transfer afterglow excited by intense electrical discharges in high pressure helium nitrogen mixtures”, J. Chem. Phys., vol. 77, pp. 817-820, 1982.
(7) R. Deloche, P. Monchicourt, M. Cheret, and F. Lambert, “High-pressure helium afterglow at room temperature”, Phys. Rev. A, vol. 13, pp. 1140-1176, 1976.
(8) A. Cenian, A. Chernukho, and V. Borodin, “Modeling of plasma-chemical reactions in gas mixture of CO2 laser”, Contribution to Plasma Physics, vol. 35, pp. 273-296, 1995.
(9) L. L. Alves, G. Gousset, and C. M, Ferreira, “A collisional-radiative model for microwave discharges in helium at low and intermediate pressures”, J. Phys. D: Appl. Phys., vol. 25, pp. 1713-1732, 1992
(10) T. Quinteros, H. Gao, D. R. DeWitt, R. Schuch, S. Pajek, S. Asp, and D. Belkic, “Recombination of D+ and He+ ions with low energy free electrons”, Phys. Rev. A, vol. 51, pp. 1340-1346, 1995.
(11) P. C. Hill and P. R. Herman, “Reaction processes in a He₂⁺(²IIᵤ a₂Σ_{g}⁺) flash lamp”, Phys. Rev. A., vol. 47, pp. 4837-4844, 1993.
(12) I. A. Kossyl, A. Yu Kostinsky, A. A. Matveyev, and V. P. Silakov, “Kinetic scheme of the non-equilibrium discharge in nitrogen-oxygen mixtures”, Plasma Source Science and Tech, vol. 1, pp. 207-220, 1992.
(13) Tochikubo et al, (supra).

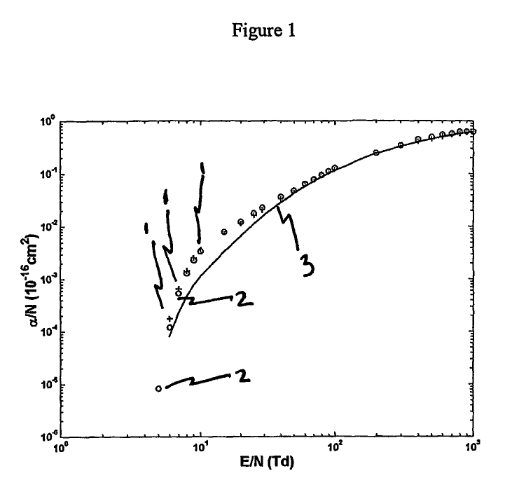

Ionization coefficients in helium can be evaluated using Ward's formula (A. L. Ward, supra) or experimental data compiled by Dutton (supra). Both agree well with those used in Massines et al (supra), particularly at large reduced electric field (>50 Td). Our model uses Ward's formula. On the other hand, it is known from spectroscopic measurements that discharge dynamics in atmospheric helium is very strongly affected by the presence of impuries, particularly nitrogen. For diffuse nonthermal atmospheric helium discharges, the presence of nitrogen impuries has been either ignored or implemented with its ionization coefficient approximated by that of argon. Since argon has a greater ionization coefficient that nitrogen, the approximation of using argon ionization coefficient overestimates the ionization of nitrogen impurities. To this end, we note that it is possible to formulate analytically ionization source terms for discharges in argon, helium, and nitrogen (See Peres, supra). Thus under the same conditions

$$\frac{{α}_{A}}{{α}_{B}} = \frac{ionization source term for species A}{ionization source term for species B} \qquad ( 2 )$$

where α is Townsend's first ionization coefficient with its subscript A and B indicating respectively species A and B. If species A is argon and species B is helium, the above formula can be used to predict the ionization coefficient of argon from that of helium as calculated from Ward's formula. As shown in FIG. 1, the argon ionization coefficient calculated with this technique, indicated by crosses 1 leads to an excellent agreement with that computed using a Boltzmann solver (see Massines et al, supra), indicated by circles 2. Therefore equation 2 offers a simple yet reliable way to estimate the ionization coefficient of one gas from the known ionization coefficient of a reference gas. Similarly if we assume species A is nitrogen and B is helium, the ionization coefficient of nitrogen is obtained and this is shown in FIG. 1, indicated by the solid line 3, as a function of the reduced electric field. The ionization coefficient thus calculated is used in our model for nitrogen (reaction #2 in Table 1). For excitation coefficients, we use that employed by Ben Gadri (supra). Similarly our model employs the same data used by Ben Gadri (supra) for diffusion coefficients and drift velocity. By way of example, and demonstration of the utility of the model presented above to accurately and correctly predict the evolution and properties of atmospheric diffuse nonthermal gas plasmas, a simulation is now presented, as follows.

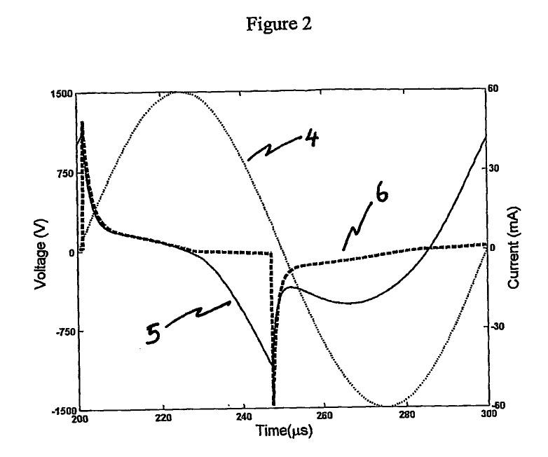

In this example, we consider a system with the two electrodes having a common radius of 2 cm and separated with a gap fixed at 0.5 cm. The total capacitance of the dielectric coatings on the two parallel-plate electrodes is 70 pF, and the source resistor in the external circuit is 50Ω. In this reference case, we consider a sinusoidal source voltage at 10 kHz with a peak voltage of 1.5 kV. Before the power supply is switched onto the plasma rig, the two electrodes are charged at 950V and so the initial gas voltage is 950V. The background gas is 99.5% helium with 0.5% nitrogen unless otherwise stated, and its breakdown voltage is assumed to be 1.1 kV, similar to the choice in Massines et al (supra). The secondary electron emission coefficient is dependent on the surface condition of electrodes and as such it is not possible to choose a reliable coefficient that is applicable to most cases. Numerically different secondary emission coefficients in the 0.01-0.2 range affect the peak value of the discharge current. For numerical studies considered here, we choose 0.2 for atomic helium ions, 0.1 for molecular helium ions, and 0.01 for nitrogen ions (see A. von Engel, “Ionized Gases”, Chapter 3, reprinted by American Institute of Physics, 1994). Our numerical model assumes that diffuse nonthermal atmospheric plasma is established if its voltage and current are continuous and repetitive over at least 10 cycles of the applied voltage signal. Noting that discharge currents of both thermal plasmas and streamer-dominated nonthermal atmospheric plasmas tend to exhibit microscopic current pulses in tens nanosecond or less, pulse duration of the discharge current is an additional indicator for diff-use atmospheric plasmas. FIG. 2 shows a plot of the applied voltage 4, the gas voltage 5, and the discharge current 6 as a function of time. Though not shown in FIG. 2, numerical results confirm that the discharge current 6 is in fact identical through many tens of cycles of the applied voltage 4 and so the discharge plasma is stable and repetitive temporally over a long period of time. The voltage-current characteristics are very similar to that obtained in a comparable experiment and its numerical simulation (Massines et al, supra), with a typical pattern of one discharge every half cycle of the applied voltage. Both gas voltage 5 and discharge current 6 exhibit very similar waveforms as those observed by Massines et al (supra) and Tochikubo et al (supra). The peak discharge current 6 in FIG. 2 is between 52-58 mA, lower than 90 mA calculated by Massines et al. As shown in FIG. 1, this may be partly due to the use of the larger ionization coefficient of argon used by Massines et al to approximate the nitrogen ionization coefficient. It is interesting to note that the peak current density of 7.2 mA/cm² (=90 mA/π2²) is the highest reported for diffuse atmospheric helium discharges generated between dielectrically coated electrodes and at kilohertz frequencies. In a series of very similar experiments performed at Tennessee University, the peak current density is found at most 1 mA/cm² (J. R. Roth, “Industrial plasma engineering”, Chapter 12, vol. 1, IoP publishing, Bristol, 1995.). A similar peak current density of about 0.4 mA/cm² (=11.25 mA/π3²) was measured with 3 kHz plasma excitation by the Okazaki group at Sophia University in Japan (T. Yokoyama, M. Kogoma, T. Moriwaki, and S. Okazaki, “The mechanism of the sterilisation of glow plasmas at atmospheric pressure”, J. Phys. D: Appl. Phys., vol. 23, pp. 1125-1128, 1990), whereas another Japanese group measured 1.8 mA/cm² with a 100 kHz power supply. More recently a helium discharge experiment performed at Minnesota University recorded a peak current density measured at 0.5 mA/cm² with 15 kHz driving voltage (L. Mangolini, K. Orlov, U. Kortshagen, H. Heberlein, and U. Kogelschatz, “Radial structure of low-frequency atmospheric-pressure glow discharge in helium”, Appl. Phys. Lett., vol. 80, pp. 1722-1724, 2002). Our computed current density of 4.4 mA/cm² (=55 mA/π2²) falls between these experimental measurements, indicating a good current prediction capability of our model.

Electric power consumption in the plasma is found to be 298 mW/cm³ from our model. This is almost identical to 300 mW/cm³ measured by Massines et al (supra) and similar to 277 mW/cm³ measured by Chen et al (Z. Chen, J. E. Morrison, R. Ben Gadri, and J. R. Roth, “A low-frequency impedance matching circuit for a one atmospheric uniform glow discharge plasma reactor”, paper 6P63, presented at the 25^{th} IEEE International Conference on Plasma Science, Raleigh, USA, June 1998). We have also calculated electron density and ion density across the space between the two electrodes. The time and spatial variation of electron density is similar to that computed in Massines et al (supra). A rapid rise of electron density occurs near 250 μs and is a result of the gas ionisation (or discharge) in that half cycle (250-300 μs), and the relatively uncharged electron density peak during the remaining period of the half cycle suggests a phase of inactive electron production. The peak electron density predicted with our model is 0.95×10¹⁰ cm⁻³, not very dissimilar to 2×10¹⁰ cm⁻³ by Tochikubo et al (supra) but much lower than 30×10¹⁰ cm⁻³calculated by Massines et al (supra). Again the large electron density reported by Massines et al (supra) may be a result of their overestimated ionization coefficient for nitrogen (see FIG. 1). For diffuse atmospheric helium plasmas, there is very little data of direct measurement of electron density for comparison with our calculated electron density. However indirectly the ion-trapping mechanism proposed by Roth (supra) may be used to estimate the average electron density and this can be captured by the following equation:

$${n}_{e} = \frac{2 m {v}_{c} {P}_{av}}{{e}^{2} {E}_{0}^{2}} \qquad ( 3 )$$

where nₑ is the average electron density, m electron mass, e electron charge, v_{c} electron collision frequency in helium, Pₐᵥ the average electric power density consumed in the plasma, and E₀ the peak electric field in the plasma. Assuming Pₐᵥ=300 mW/cm³, E₀=3 kV/cm, and v_{c}=1.8×10¹² Hz (see Roth, supra), eq. (3) yields 4.3×10⁸ cm⁻³. Given that the peak electron density is approximately 10-50 times greater than the calculated average electron density, the above calculation suggests that the peak electron density is between 4×10⁹ cm⁻³ and 2×10¹⁰ cm⁻³. Thus our calculated peak electron density appears reasonable. This is also confirmed by electron density estimate using the current density formula of J=enₑμE (where μ is the electron mobility) as employed for measuring electron density in micro-hollow cathode discharges (see R. H. Stark and K. H. Schoenbach, “Direct current high-pressure glow discharges”, Journal of Applied Physics, vol. 85, pp. 2075-2080, 1999). In general our simulated voltage-current characteristics, the peak discharge current density, the plasma power density, and the electron density yield a favourable comparison with available experimental and numerical data of comparable diffuse atmospheric helium discharges. While there is much scope to include other features of diffuse atmospheric plasmas, for example multi-dimensional effects, our plasma model described above is capable of capturing the main plasma features accurately and as such it will be used to explore the benefits of plasma pulsing.

The underlying inventive concept, realising a benefit of energy saving is best understood from the voltage-current characteristic in FIG. 2 (Massines et al, supra). It is seen that the discharge current 6 is of very low magnitude after its peak between 207 μs-245 μs in the half-cycle from 200 μs to 250 μs, when the applied voltage 4 is very large. This suggests that between the instant of this discharge current pulse and the polarity reversal point (that occurs at around 250 μs) of the applied voltage 4 in the same half cycle the applied voltage 4 does not necessarily contribute to plasma generation but may adversely heat up electrons. Through energy transfer from electrons to heavy particles, this undesirable electron heating would increase gas temperature. Therefore by reducing the applied voltage 4 over this “inactive” period of electron production, the gas temperature may be lowered and equally importantly the input power can be reduced.

### Description of the Preferred Embodiments

We will now describe preferred embodiments of the invention by means of four examples. The first uses a waveform essentially comprising a peak-levelled sinusoid. The second employs a ‘tail-trimmed’ sinusoid, and the third employs a ‘tail-shaped’ sinusoid. The fourth example describes how a control system can be used to shape the waveform of the applied voltage in response to the resultant discharge current.

### EXAMPLE 1

### Peak-Levelled Sinusoid

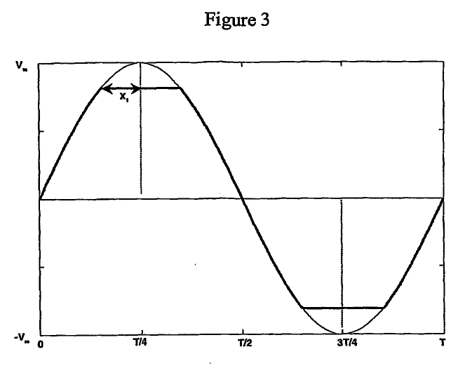

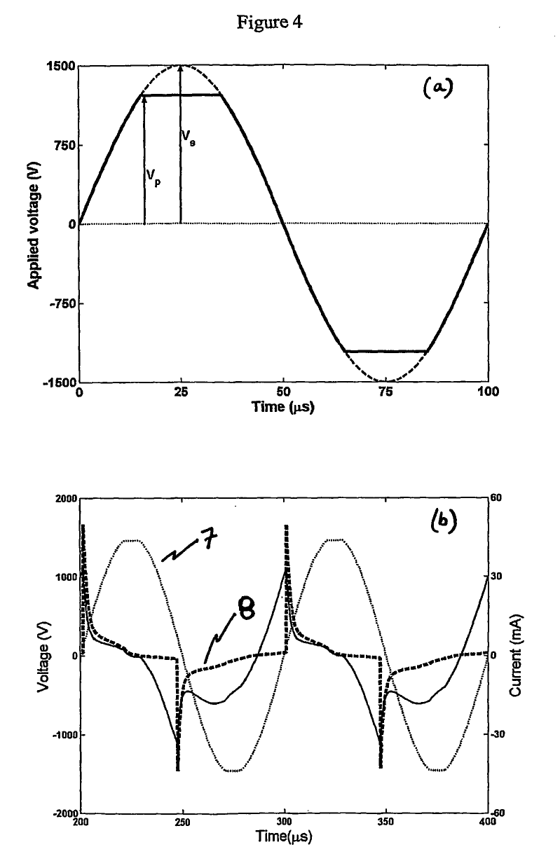

We first consider a simple pulsed excitation voltage waveform, shown in FIG. 4a, which is essentially derived from a sinusoidal wave with its peak (positive and negative) levelled to a flat top. Voltage waveform of FIG. 4a can be easily obtained electronically, and so it represents a realistic option. By reference to FIG. 3, the general equation describing the peak-levelled pulse waveform, V(t), is as follows:

$$V ( t ) = \{ \begin{matrix}{V}_{m} sin ( \frac{π}{2} - {x}_{1} ) & ( \frac{π}{2} - {x}_{1} ) < rem ( 2 π ft , 2 π ) < ( \frac{π}{2} + {x}_{1} ) , \\ {V}_{m} sin ( \frac{3 π}{2} - {x}_{1} ) & ( \frac{3 π}{2} - {x}_{1} ) < rem ( 2 π ft , 2 π ) < ( \frac{3 π}{2} + {x}_{1} ) , \\ {V}_{m} sin ( 2 π ft ) & elsewhere\end{matrix} \\ where \text{:} \\ 0 \leq {x}_{1} < \frac{π}{2}$$

and:

rem(2π f t, 2π) gives the remainder after the division (2π f t)/2π.

With reference to FIG. 4, the magnitude of the original sinusoidal voltage, Vₛ, is fixed at 1.5 kV, whereas that of the peak-levelled voltage 7, Vₚ, varies from 0.4 kV to 1.5 kV. The repetition frequency of the excitation voltage remains at 10 kHz.

FIG. 4b shows the voltage and current characteristics of a diffuse nonthermal atmospheric gas discharge generated with Vₚ=1.2 kV. The discharge current 8 remains repetitive and stable through many tens of cycles of the applied voltage 7. Therefore under the conditions considered here, pulsing the plasma-generating voltage 7 does not appear to significantly affect the establishment of diffuse nonthermal atmospheric plasma. More specifically the waveform of the discharge current 8 remains relatively unchanged from that under the sinusoidal excitation, and the peak current is again around 55 mA very similar to the sinusoidal case of FIG. 2.

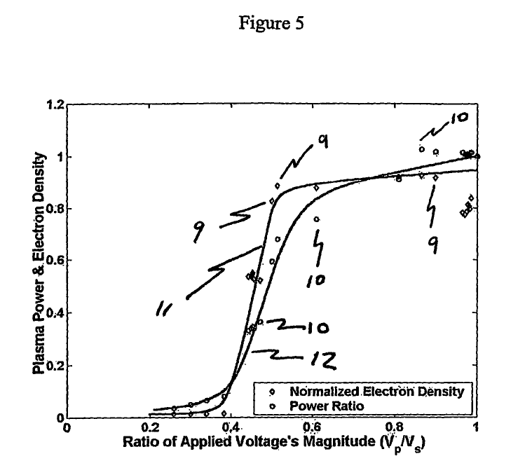

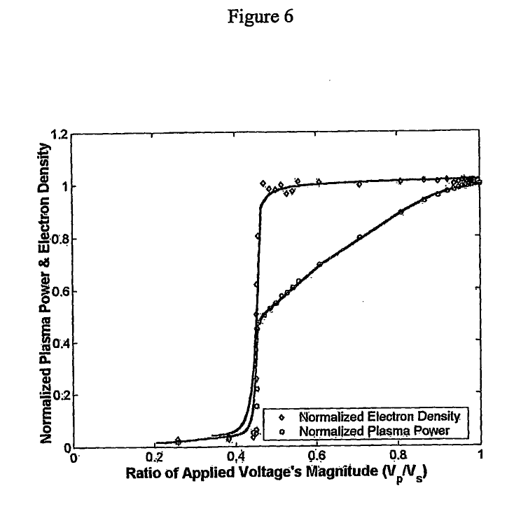

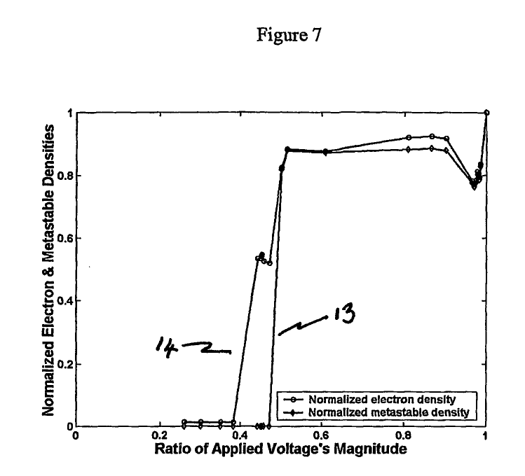

The basic voltage-current characteristics remain relatively unchanged until Vₚ decreases below 750V when the generated plasma becomes unsustainable and eventually extinguishes. This is illustrated in FIG. 5 where the normalized electron density shown by diamonds 9 and the normalized plasma power density shown by circles 10 are plotted against the normalized magnitude of the applied voltage, Vₚ/Vₛ. The normalizations of electron density and plasma power density in this figure, and in FIGS. 6 and 7 are carried out with respect to the electron density and plasma power density obtained by sinusoidal excitation, as illustrated in FIG. 2). Lines 11 and 12 are drawn through the electron density data 9 and the plasma power density data 10 respectively, to guide the eye. It is evident that when Vₚ/Vₛ>0.5 plasma pulsing does not significantly affect electron density while the plasma power is reduced by up to 40%. Further numerical simulations suggest that ion densities are also largely unaffected as long as Vₚ/Vₛ>0.5. Given that electron and ion densities remain approximately the same and that the discharge current and the gas voltage undergo relatively small changes, the basic plasma characteristics should remain relatively unchanged. In other words voltage pulsing in FIG. 4 is unlikely to affect adversely plasma-activated applications that rely on the production of electrons or/and ions, yet is capable of considerable power saving.

It is found that the amount of power saving is dependent on that of nitrogen impuries. In the case of very little nitrogen impurities (<0.01%), numerical studies suggest a power saving of more than 50% as indicated in FIG. 6. Again such significant power saving is achieved without affecting the production of electrons and ions. Also found is that the power saving is not at the expense of the production of excited neutral species either. With 0.5% nitrogen, FIG. 7 shows the normalized density of He(2³S) 13 as a function of the Vₚ/Vₛ ratio. It is evident that the trend of the metastable density 13 effectively tracks that of the electron density 14. So if the plasma power is reduced with the electron density 14 kept approximately the same as that with sinusoidal excitation (without pulsing), the metastable density 13 will also remain at approximately the same level as its value with sinusoidal excitation.

The density tracking between electrons and metastables suggests a key role played by electrons in influencing production of excited neutral species in diffuse atmospheric gas discharges. It is known that energy required to excite neutral species and create chemically reactive species is usually provided through the kinetic energy of electrons. There are also reactive species whose densities are directly proportional to electron density. For example, densities of most oxygen species (e.g. atomic oxygen, singlet-sigma metastable oxygen, singlet-delta metastable oxygen) in a diffuse nonthermal atmospheric discharge in an oxygen-helium mixture are found to proportional to P_{RF}^{m} where m=0.8−1.9 and P_{RF} is the input RF power to the generated plasma (see J. Y. Jeong, J. Park, I. Henins, S. E. Babayan, V. J. Tu, G. S. Selwyn, G. Ding, and R. F. Hicks, “Reaction chemistry in the afterglow of an oxygen-helium atmospheric plasma”, J. Phys. Chem., vol. 104, pp. 8027-8032, 2000). According to eq. (3), these oxygen densities are also proportional to electron density. Therefore the very similar electron densities in the sinusoidal case of FIG. 2 and the pulsed case of FIG. 4 may be a good basis to consider that the densities of most reactive species in the two cases would be similar and so would their chemical reactivity. Thus it is possible to produce at least some reactive species electrically efficiently with voltage pulsing, and as such this will also be useful for applications that reply on reactive species. It is important to note however that in general there is no direct correlation between electron density and densities of all reactive species. There are reactive species whose densities may be inversely proportional to electron density, for example ozone in the oxygen-helium plasma mentioned Jeong et al (supra). So for individual diffuse nonthermal atmospheric plasmas, the suggested maintenance of production of reactive species deduced from that of electron production needs to be assessed carefully. Our observation is that it is possible for diffuse nonthermal atmospheric plasmas to maintain densities of some reactive species with reduced electric power.

### EXAMPLE 2

### Tail-Trimmed Waveform

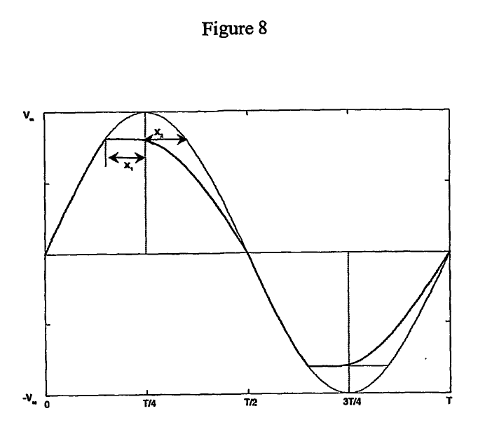

An alternative embodiment to achieve the benefits of the invention may be referred to as a tail-trimmed pulse waveform. With reference to FIG. 8, such a waveform may be described by the following equations:

$$\begin{matrix}\begin{matrix}V ( t ) = \\ \{ \begin{matrix}{V}_{m} sin ( \frac{π}{2} - {x}_{1} ) & ( \frac{π}{2} - {x}_{1} ) < rem ( 2 π ft , 2 π ) \leq ( \frac{π}{2} + {x}_{1} - {x}_{2} ) , \\ {V}_{m} sin ( \frac{π}{2} - {x}_{1} ) sin ( 2 π {f}^{′} t + θ ) & ( \frac{π}{2} + {x}_{1} - {x}_{2} ) < rem ( 2 π ft , 2 π ) < π , \\ {V}_{m} sin ( \frac{3 π}{2} - {x}_{1} ) & ( \frac{3 π}{2} - {x}_{1} ) < rem ( 2 π ft , 2 π ) < ( \frac{3 π}{2} + {x}_{1} - {x}_{2} ) , \\ {V}_{m} sin ( \frac{π}{2} - {x}_{1} ) sin ( 2 π {f}^{′} t + θ ) & ( \frac{3 π}{2} + {x}_{1} - {x}_{2} ) < rem ( 2 π ft , 2 π ) < 2 π \\ {V}_{m} sin ( 2 π ft ) & elsewhere\end{matrix}\end{matrix} \\ where \text{:} \\ 0 \leq {x}_{1} \leq \frac{π}{2} \\ 0 \leq {x}_{2} \leq 2 {x}_{1} \\ {T}^{′} = 2 ( \frac{1}{2} - \frac{{x}_{1}}{π} + \frac{{x}_{2}}{π} ) T \\ {f}^{′} = \frac{1}{{T}^{′}} \\ θ = ceil ( 2 ft ) π ( 1 - \frac{{f}^{′}}{f} )\end{matrix}$$

and where ceil(2 f 1) rounds (2 f t) to the nearest integer towards infinity.

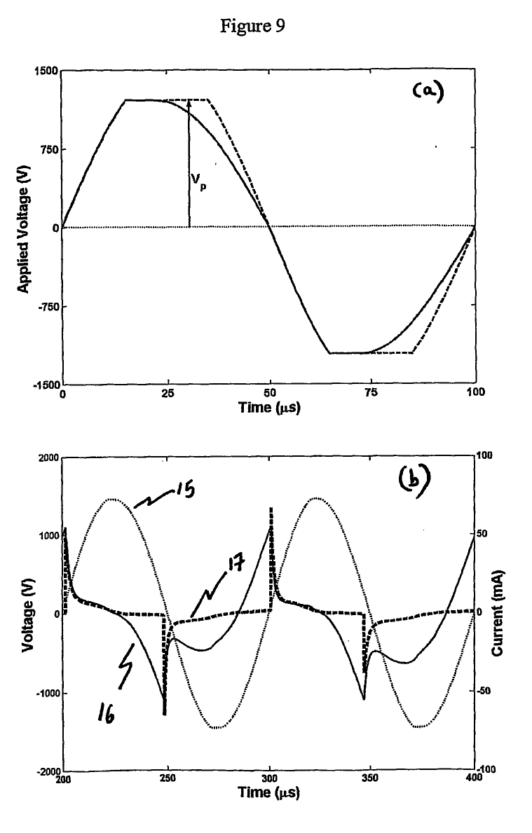

With reference to FIG. 9a, the “tail-off” phase of the applied voltage in (between 25 μs and 50 μs) may be trimmed to further enhance energy efficiency for plasma generation. The voltage-current characteristics of the induced atmospheric plasma from this waveform are shown in FIG. 9b, where 15 is the applied voltage, 16 is the gas voltage, and 17 is the discharge current. It is evident that moderate voltage trimming does not significantly affect the generation and characteristics of induced nonthermal atmospheric plasmas, though the discharge current 17 has different peak values in different half cycles. Numerical studies suggest that further power saving is possible but very modest, typically a few percent and at best 10% before electron density starts to decrease.

We have so far established that generation of diffuse nonthermal atmospheric plasmas can be made more efficient by altering the waveform of the applied voltage without affecting the basic plasma characteristics.

### EXAMPLE 3

### Tail-Shaped Waveform

In this example, we consider how pulse width may affect plasma generation. In this example we consider one particular type of pulsed voltage signal constructed from a sinusoidal signal for the voltage rise phase and a Gaussian decay for the voltage tail phase. Mathematically in each cycle they may be expressed as follows

$$V ( t ) = \{ \begin{matrix}{V}_{0} sin ω t & if 2 N π \leq t < {t}_{0} + 2 N π \\ {V}_{p} exp [ - {( t - {t}_{0} - 2 N π )}^{2} / {τ}^{2} ] & if {t}_{0} + 2 N π \leq t < 2 N π + π \\ {V}_{0} sin ω t & if 2 N π + π \leq t < {t}_{0} + 2 N π + π \\ - {V}_{p} exp [ - {( t - {t}_{0} - 2 N π - π )}^{2} / {τ}^{2} ] & if {t}_{0} + 2 N π + π \leq t < 2 N π + 2 π\end{matrix} \qquad ( 4 )$$

where V₀ is the peak voltage of the sinusoidal signal, Vₚ is the peak voltage of the Gaussian decay signal, τ is the pulse width of the Gaussian signal, ω=2π/T is the angular frequency of the applied voltage with T being its period, and t₀ the instant at which the sinusoidal and the Gaussian signals joint. T₀ and t₀ are defined as follows:

$$\begin{matrix}{T}_{0} = \frac{T}{2 π} arcsin [ \frac{{V}_{p}}{{V}_{0}} ] \\ {t}_{0} = {T}_{0} + kT / 2 \\ k = mod ( t , T / 2 )\end{matrix} \qquad ( 5 )$$

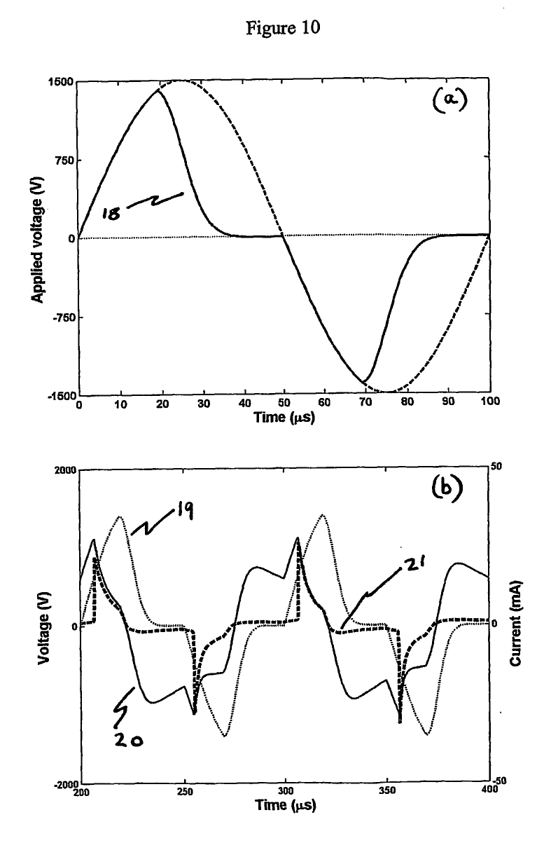

To compare to the sinusoidal case of FIG. 2, we set V₀=1.5 kV, _{Vp}=1.4 kV, and τ=T/8. The waveform of the applied voltage 18 is shown in FIG. 10a, and the voltage and current signals of the generated atmospheric plasma is shown in FIG. 10b, where 19 is the applied voltage, 20 is the gas voltage, and 21 is the discharge current. It is evident that the pattern of one discharge every half cycle remains and this is repetitive for many tens of cycles. On the other hand, the gas voltage is markedly different from that in the sinusoidal case of FIG. 2. Particularly it has a large hump preceding the main peak that causes the discharge event in each half cycle. Also after the discharge event where the discharge current peaks, the gas discharge does not reduce to zero as rapidly as in the sinusoidal case.

The discharge current 21 is between 30-45 mA, markedly lower than 55 mA calculated for the sinusoidal case. Interestingly the pulse width of the discharge current 21 is much larger than that in the sinusoidal case (FIG. 2), particularly for the positive half cycles. For the case in FIG. 10, electric power density consumed in the plasma is about 0.32 W/cm³, about 7% above that in the sinusoidal case. Further numerical examples studied suggest that under other pulsing conditions diffuse atmospheric helium plasmas excited with the pulsed voltage of FIG. 10a consume approximately the same amount of electric power as those with sinusoidal excitation. Therefore shortening the pulse width may not be as effective in achieving energy saving on an absolute basis, but, as discussed below, have advantages in energy-saving for a given density of electrons and metastables achieved. From the voltage-current characteristic, this is likely due to the wider pulse widths for both the discharge current and the gas voltage. On the other hand, electron density achievable can be much higher. For the case shown in FIG. 10b, the peak electron density is found to be 1.74×10¹⁰ cm⁻³, 83% above 0.95×10¹⁰ cm⁻³ for the sinusoidal case. The spatial variation of electron density over one half cycle shows a similar distribution to that that produced by the sinusoidal waveform presented above yet with clear difference near the voltage polarity reversal point. There is a clear evidence of pulsed production of electrons. Further numerical calculations suggest that by changing the pulse width of the applied voltage in FIG. 10a, electron and metastable densities can be made much greater than that under sinusoidal excitation. Though inappropriate wave-shaping of the applied voltage can also reduce electron and metastable densities, the above discussions suggest that through control of pulse width it is possible to enhance production of electrons and metastables for a given plasma power consumption. To see this more clearly, we calculate the ratio of electron density to plasma power density (number of electrons that can be produced at a given input power). This is 5.4×10¹⁰/W for this example, and 3.2×10¹⁰/W for the sinusoidal waveform presented above, an improvement of 68%. From this comparison, it is still electrically efficient to pulse the applied voltage for the generation of diffuse nonthermal atmospheric plasmas.

### EXAMPLE 4

### Controlled Waveform

It is clear that an optimal saving of energy in the production of gas plasmas may be obtained by the use of a control system, such as a feedback control system, wherein the waveform of the applied voltage is driven by the control system, which itself uses the discharge current as an input variable. In this way, the voltage signal may be attenuated following the plasma discharge, so as to make most efficient use of the input energy. The use of such a control system can then also take account of any temporal changes in the system configuration (such as changes in electrode or dielectric coating characteristics, or changes in the gas composition), leading to waveforms (as defined herein) that may vary in their repetition rate, and which may vary in peak shape and amplitude from cycle to cycle.

Parametric Ranges of Key System Variables

Electrode size: Typically between 50 cm² and 100 cm² of either circular or rectangular shapes. Scaling up is possible, with the electrode area divided into different sections connected in parallel to the supply power source. To control plasma stability with large electrodes, it may be useful to use individually valued series resistors or impedance networks in each of these parallel circuit branches. On the other hand, plasma stability is easier to achieve with smaller electrodes than 50 cm².

Electrode separation: Typically around 1 cm. Smaller electrode separation makes it easier to control plasma stability. Although larger electrode separation tends to unstabilise the generated nonthermal plasma, it is quite possible to increase the electrode separation up to tens of centimetres, especially when the electrode area is large and the electric power pulsed.

Capacitance of dielectric coatings: For the case where at least one of the electrodes has a dielectric coating, their capacitance depends on the size of the electrodes and hence that of the dielectric. Typically for a surface area of 10 cm² the capacitance of one dielectric coating is between 10 pF and 100 pF. If the surface area of the dielectric coatings is increased, the capacitance increases proportionally. Also it is equally acceptable to coat either one electrode or both electrodes, the latter of which will have the coating capacitance halved.

Peak voltage: This depends on the repetition frequency, the electrode separation, and gas composition. At a repetition frequency of 10 kHz and an electrode separation of 0.5 cm, the peak voltage needs to be greater than 1.0 kV but usually less than 2 kV in helium or helium mixed with a small fraction of nitrogen or/and oxygen (typically less than 1%). This needs to be increased when the electrode separation is increased. At a greater repetition frequency on the other hand, the peak voltage required becomes smaller. For example between 10 and 20 MHz, the peak voltage can be reduced to as low as 500V in helium with 0.5 cm electrode separation.

Gas composition: Our numerical work was performed for helium-nitrogen mixture. For applications, helium-oxygen is more useful and argon-oxygen is even better as argon is cheaper than helium. The most practically convenient gas is air (though very difficult to simulate). Alternatively noble gases mixed with a small fraction of a reactive gas (such as, but not limited to, oxygen can be used.

t₀ in the Gaussian decay function: t₀ is given in equation 4 and 5 in Example 3 of the preferred embodiments. Typically it is between 5% and 15% of the repetition period of the applied electric voltage.

### SUMMARY

Diffuse nonthermal gas discharges generated at atmospheric pressure have found increasing applications in many key materials processing areas such as etching, deposition, and structural modification of polymeric surfaces. To facilitate tailored and improved applications of these novel gas plasmas, we consider their pulsed generation based on one-dimensional numerical simulation of helium-nitrogen discharges. We consider four waveforms of the plasma-generating voltage, namely (1) sinusoidal; (2) peak-levelled sinusoidal; (3) peak-levelled and tail-trimmed sinusoidal; and (4) pulsed with a Gaussian-shaped tail, all at the same repetition frequency of 10 kHz. For each case, voltage and current characteristics are calculated and then used to assess whether the generated plasma is diffuse and nonthermal. Densities of electrons, ions, and metastables are calculated, together with the dissipated electric power in the plasma bulk. It is found that plasma pulsing can significantly reduce the electric power needed to sustain diffuse nonthermal atmospheric plasmas. Specifically by choosing appropriate pulse shape, the plasma-sustaining power can be reduced by more than 50% without reducing densities of electrons, ions, and metastables. On the other hand, electron density can be enhanced by 68% with the same input electric power if the pulse width is suitably narrowed.

### SCOPE OF THE INVENTION

The invention is defined in the Claims, which now follow, and in which the term “waveform” is understood to include periodic signals that have a zero value over more than an instantaneous part of the period, and which are more commonly referred to as “pulse trains”.

In the Claims, the term “truncated” is taken to include limited in amplitude to a maximum and/or minimum voltage, such limitation typically leading to a waveform with a substantially flat profile at its extreme value or values, and/or to include narrowed in pulse width.

In the Claims, Equation E1 is taken to be:

$$V ( t ) = \{ \begin{matrix}{V}_{m} sin ( \frac{π}{2} - {x}_{1} ) & ( \frac{π}{2} - {x}_{1} ) < rem ( 2 π ft , 2 π ) < ( \frac{π}{2} + {x}_{1} ) , \\ {V}_{m} sin ( \frac{3 π}{2} - {x}_{1} ) & ( \frac{3 π}{2} - {x}_{1} ) < rem ( 2 π ft , 2 π ) < ( \frac{3 π}{2} + {x}_{1} ) , \\ {V}_{m} sin ( 2 π ft ) & elsewhere\end{matrix} \\ where \text{:} \\ 0 \leq {x}_{1} < \frac{π}{2}$$

and:

rem(2π f t, 2π) gives the remainder after the division (2πf)/2π.
and further, Equation E2 is taken to be:

$$\begin{matrix}\begin{matrix}V ( t ) = \\ \{ \begin{matrix}{V}_{m} sin ( \frac{π}{2} - {x}_{1} ) & ( \frac{π}{2} - {x}_{1} ) < rem ( 2 π ft , 2 π ) \leq ( \frac{π}{2} + {x}_{1} - {x}_{2} ) , \\ {V}_{m} sin ( \frac{π}{2} - {x}_{1} ) sin ( 2 π {f}^{′} t + θ ) & ( \frac{π}{2} + {x}_{1} - {x}_{2} ) < rem ( 2 π ft , 2 π ) < π , \\ {V}_{m} sin ( \frac{3 π}{2} - {x}_{1} ) & ( \frac{3 π}{2} - {x}_{1} ) < rem ( 2 π ft , 2 π ) < ( \frac{3 π}{2} + {x}_{1} - {x}_{2} ) , \\ {V}_{m} sin ( \frac{π}{2} - {x}_{1} ) sin ( 2 π {f}^{′} t + θ ) & ( \frac{3 π}{2} + {x}_{1} - {x}_{2} ) < rem ( 2 π ft , 2 π ) < 2 π \\ {V}_{m} sin ( 2 π ft ) & elsewhere\end{matrix}\end{matrix} \\ where \text{:} \\ 0 \leq {x}_{1} \leq \frac{π}{2} \\ 0 \leq {x}_{2} \leq 2 {x}_{1} \\ {T}^{′} = 2 ( \frac{1}{2} - \frac{{x}_{1}}{π} + \frac{{x}_{2}}{π} ) T \\ {f}^{′} = \frac{1}{{T}^{′}} \\ θ = ceil ( 2 ft ) π ( 1 - \frac{{f}^{′}}{f} )\end{matrix}$$

nd where ceil(2 f t) rounds (2 f t) to the nearest integer towards infinity.
and Equation E3 is taken to be:

$$V ( t ) = \{ \begin{matrix}{V}_{0} sin ω t & if 2 N π \leq t < {t}_{0} + 2 N π \\ {V}_{p} exp [ - {( t - {t}_{0} - 2 N π )}^{2} / {τ}^{2} ] & if {t}_{0} + 2 N π \leq t < 2 N π + π \\ {V}_{0} sin ω t & if 2 N π + π \leq t < {t}_{0} + 2 N π + π \\ - {V}_{p} exp [ - {( t - {t}_{0} - 2 N π - π )}^{2} / {τ}^{2} ] & if {t}_{0} + 2 N π + π \leq t < 2 N π + 2 π\end{matrix}$$

In all of which equations E1, E2 and E3, the parameters are to be interpreted as described herein.

1. A method of generating a gas plasma characterised by the feature that the applied voltage exhibits a waveform selected from the group consisting of: a waveform which is truncated, a waveform which decays asymmetrically from its peak value; and a waveform which is truncated and which decays asymmetrically from its peak value.

2. (canceled)

3. (canceled)

4. The method as claimed in claim 1, wherein the applied voltage, V, as a function of time, t, said time t being measured from any arbitrary instant, takes the form of a waveform, V(t), of cycle time T, wherein in at least one of the half cycles, i.e. between (t=i T) and (t=i T+T/2) or between (t=i T+T/2) and (t=(i+1)T), where i takes integer values, the waveform is characterised by the magnitude of the integral of the voltage with respect to time being greater in the first half of said half cycle than in the second half of said half cycle.

5. The method as claimed in claim 1, wherein the applied voltage, V, as a function of time, t, said time t being measured from any arbitrary instant, takes the form of a waveform, V(t), of cycle time T, wherein at least one of the half cycles, i.e. between (t=iT) and (t=iT+T/2) or between (t=iT+T/2) and (t=(i+1)T), where i takes integer values, the waveform is characterised by a period of substantially constant voltage.

6. The method as claimed in claim 5, wherein the applied voltage is defined by equation E1 herein.

7. The method as claimed in claim 4, wherein the applied voltage is defined by equation E2 herein.

8. The method as claimed in claim 4, wherein the applied voltage is defined by equation E3 herein.

9. The method as claimed in claim 1, wherein the applied voltage is generated by the action of a control system, said control system using a measurement of the plasma discharge current as an input signal.

10. A method for generating a non-thermal atmospheric gas plasma comprising:
applying a voltage having a periodic voltage waveform across a gas, thereby causing a current to flow through the gas, wherein the maximum magnitude of the voltage in each period is closer in time to a first preceding maximum in the magnitude of the current than to a second following maximum in the magnitude of the current and wherein the voltage waveform follows a sinusoidal function in a portion preceding the maximum magnitude of the voltage and is reduced below said sinusoidal function in a portion following the maximum magnitude of the voltage.

11. The method for generating a non-thermal atmospheric gas plasma as claimed in claim 10, wherein, in a single period, the magnitude of the voltage waveform comprises a positive gradient in a first portion of time, a zero gradient in a second portion of time and a negative gradient in a third portion of time.

12. The method for generating a non-thermal atmospheric gas plasma as claimed in claim 11, wherein a maximum magnitude of the gradient of the voltage in the first portion of time is greater than a maximum magnitude of the gradient of the voltage in the third portion of time.

13. The method for generating a non-thermal atmospheric gas plasma as claimed in claim 11, wherein in the single period, the voltage waveform further comprises a zero gradient in a fourth portion of time.

14. The method for generating a non-thermal atmospheric gas plasma as claimed in claim 13, wherein the single period consists of, in order, the first, second, third and fourth portions of time.

15. The method for generating a non-thermal atmospheric plasma as claimed in claim 10, wherein the voltage waveform is non-sinusoidal.

16. (canceled)

17. A method of generating a non-thermal atmospheric gas plasma characterised by applying a voltage having a periodic voltage waveform across a gas, thereby causing a current to flow through the gas, the voltage exhibits a waveform which decays asymmetrically from its peak value, wherein the peak value is the maximum magnitude of the voltage in each period, and wherein the peak value is closer in time to a preceding maximum in the magnitude of the current than to a second following maximum in the magnitude of the current.

18. The method as claimed in claim 17, wherein the applied voltage exhibits a waveform which is, in part, a truncated sinusoid and which decays asymmetrically from its peak value.

19. (canceled)

20. The method as claimed in claim 1, wherein the applied voltage exhibits a waveform which is a truncated sinusoid.
